(19) United States
(12) Patent Application Publication
(10) Pub. No.: US 2015/0377759 A1
(43) Pub. Date: Dec. 31, 2015

(54) METHOD FOR FINDING SHEAR RATE OF FLUID, AND PROGRAM AND DEVICE FOR SAME

(71) Applicant: A&D Company, Limited, Tokyo (JP)

(72) Inventors: Naoto IZUMO, Saitama (JP); Masahiro KANNO, Saitama (JP)

(21) Appl. No.: 14/766,224

(22) PCT Filed: Feb. 28, 2013
(86) PCT No.: PCT/JP2013/055518

§ 371 Date: Aug. 6, 2015

(51) Int. Cl. G01N 11/16

(52) U.S. Cl. CPC G01N 11/16

(57) ABSTRACT

Provided is a new method to obtain a shear rate of a fluid and Provided are a program and a device for the method. In the method, a pair of vibrators (1,1) are vibrated by an electromagnetic drive (2) and a viscosity of the sample liquid (9) is calculated by measuring a driving current of a coil (2b), which has a step (S1) of calculating the viscosity (η) of the sample liquid (9), a step (S2) of calculating a driving force (F) on a center of a wet part of the vibrator from the driving current (I), and a step (S3) of calculating a shear stress (S) exerted on the sample liquid from the driving force (F) and a liquid contact area of the vibrator (A), wherein the shear rate (D) is calculated from a ratio between the shear stress (S) and the viscosity (S4).

### TECHNICAL FIELD

The present invention relates to a method of obtaining a shear rate regarding physical properties evaluation of a fluid, particularly, relates to a calculating method of the shear rate of the fluid and a program and a device for the method.

### BACKGROUND ART

It is known that viscosity “n” which is an important factor for evaluating physical properties of a fluid is represented by the formula (1) using a shear rate “D” which is a velocity gradient obtained in an orthogonal coordinates of a fluid space wherein a plate P and a plate Q are arranged in parallel in x direction, the plate P is fixed, and the plate Q is moved in a constant speed in the x direction, and using a shear stress “5” which is a friction per unit area to act on a plane in parallel direction to the flow direction between the plates P and Q generated from the difference of the velocities, as shown in FIG. 1. The formula (1) means the viscosity η of the fluid is obtained by the ratio between the shear stress S and the shear rate D occurring in the fluid.

η=S/D (1)

Here, particularly, it is essential, for a non Newtonian fluid of which viscosity η is changed in accordance with the change of the shear rate D, to measure the shear rate together with the measurement of the viscosity for the design of the physical properties of the fluid, because its behavior is changed depending on the change of the shear rate.

Meanwhile, as the devices evaluating the physical properties of the fluid, capillary type, falling body type, rotational type, and vibration type viscometers have been used.

The capillary type measures the viscosity by measuring a length of time during which the sample liquid flows through a constant certain flow path. The falling body type measures the viscosity by measuring a plunge time of a metal ball in the sample liquid. Therefore, both of them cannot obtain the shear rate because they measure indirectly the viscosity from the time.

Next, the vibration type cannot obtain the shear rate exerted on the fluid as a constant value with respect to the time change because its vibrator is reciprocated in the sample liquid. Therefore the types have been recognized as methods which cannot determine the shear rate (refer to the Patent Literatures 1 and 2 for a tuning fork vibration type, refer to the non-Patent Literature 1 for a rotational vibration type).

Next, the rotational type calculates the viscosity by measuring a torque necessary for keeping a rotor in a constant rotating number in the sample liquid and determines the shear rate from viewpoint that the rotating number of the rotor is directly proportional to the shear rate.

Specifically, in a cone plate rotational type viscometer, as shown in FIG. 2, when a cone rotor 32 (the rotor) dunked in a sample liquid 9 is rotated at a rotating number “N” [rpm] in the state of keeping a plate 31 calm and if the radius of the rotor 32 is defined as “r”, the shear rate D occurring in the sample liquid 9 is represented by formula (2) at any radius r, the shear rate D is irrelevant to the r and can be calculated from the rotating number N and the cone angle “φ” at any point of the cone surface (refer to the non-Patent Literature 2).

D=(2πNr/60)(1/r )=(2πN/60)(1/φ) (2)

In a coaxial double cylinder rotational type viscometer, as shown in FIG. 3, when an inner cylinder 34 (the rotor) dunked in a sample liquid 9 is rotated at a rotating number N [rpm] in the state of keeping an outer cylinder 33 calm and if the radius of the outer cylinder 33 is defined as “Rc”, the radius of the inner cylinder 34 is defined as “Rb”, and its height is defined as “h”, the shear rate D occurring in the sample liquid 9 is represented by formula (3), the shear rate D can be calculated from the rotating number N and the radiuses Rb and Rc (refer to the non-Patent Literature 2).

D=0.2094N/{1−(Rb/Rc)²} (3)

Thus, the rotational types have been recognized as methods which can determine the shear rate because they can obtain the shear rate from the rotating number N and the shapes of the rotor φ or Rb and Rc.

### CITATION LIST

### Patent Literature

Patent Literature 1: JP-A-H05-149861
Patent Literature 2: JP-A-2005-9862

### Non Patent Literature

Non Patent Literature 1: JIS Z8803 (2011)
Non Patent Literature 2: “glossary of rheology” in website of TOKI SANGYO CO., LTD. (http://www.tokisangyo.co.jp/pdf/paper/rheology_words.pdf)

### SUMMARY OF INVENTION

### Technical Problem

However, although the rotational type viscometers have been recognized as methods which can determine the shear rate, as mentioned the above, the shear rate is just obtained hypothetically by the geometric shape of the viscometer's device and the rotating number of the rotor. Therefore, there has been a problem that the ideal value reflected by the real behavior of the fluid is not provided.

The present invention is made in view of the problems of the conventional technique described the above, and an object thereof is to provide a new method to obtain the shear rate of the fluid, and to distribute the elucidation making the physical properties of the fluid more realistic by supplying a program and a device for the method.

### Solution to Problem

In order to achieve the above described object, in claim 1, the present invention is a method of obtaining a shear rate occurring in a liquid sample for a tuning fork vibration type viscometer, in which a pair of vibrators are dunked in the sample liquid and vibrated by an electromagnetic drive equipped with a coil, a driving current is applied to the coil so as to set an amplitude of the vibrators within a predetermined amplitude value, and a viscosity of the sample liquid is calculated by measuring the driving current, the method including a step of calculating the viscosity of the sample liquid, a step of calculating a driving force on a center of a wet part of the vibrator from the driving current, and a step of calculating a shear stress exerted on the sample liquid from the driving force and a liquid contact area of the vibrator, wherein the shear rate is calculated from a ratio between the shear stress and the viscosity.

In claim 2, according to the method of obtaining the shear rate claimed in claim 1, the calculation of the driving force on the center of the wet part of the vibrator in the step of calculating the driving forth includes a first step of calculating a power generated in the electromagnetic drive from a product of a density of magnetic flux, a driving current and a length of the coil of the electromagnetic drive and a second step of dividing the power generated in the electromagnetic drive by a ratio between a distance to a center of the electromagnetic drive and a distance to the center of the wet area of the vibrator on a basis of a thinnest part of a plate spring acting as a fulcrum of the vibrator.

In claim 3, the present invention is a tuning fork vibration type viscometer, in which a pair of vibrators are dunked in a sample liquid and vibrated by an electromagnetic drive equipped with a coil, a driving current is applied to the coil so as to set an amplitude of the vibrators within a predetermined amplitude value, and a viscosity of the sample liquid is calculated by measuring the driving current, the viscometer including a means of calculating the viscosity of the sample liquid, a means of calculating a driving force on a center of a wet part of the vibrator from the driving current, and a means of calculating a shear stress exerted on the sample liquid from the driving force and a liquid contact area of the vibrator, wherein the shear rate is calculated from a ratio between the shear stress and the viscosity.

In claim 4, the present invention is a program which is written in accordance with the method of obtaining the shear rate claimed in claim 1 or 2, and is executable.

In claim 5, the present invention is a method of obtaining a shear rate occurring in a liquid sample for a rotational type viscometer, in which a rotor is dunked and rotated in the sample liquid in laminar flow, a torque necessary for keeping the rotor in a constant rotating number in the sample liquid is measured, and a viscosity of the sample liquid is calculated, the method including a step of calculating the viscosity of the sample liquid, and a step of obtaining a torque value as a shear stress occurring in the sample liquid, wherein the shear rate is calculated from a ratio between the shear stress and the viscosity.

In claim 6, the present invention is a method of obtaining a shear rate occurring in a liquid sample for a rotational vibration type viscometer, in which a vibrator is dunked and resonated in a rotating direction in the sample liquid, a torque of the vibrator necessary for keeping the vibrator in a constant amplitude in the sample liquid is measured, and a viscosity of the sample liquid is calculated, the method including a step of calculating the viscosity of the sample liquid, and a step of obtaining a torque value as a shear stress occurring in the sample liquid, wherein the shear rate is calculated from a ratio between the shear stress and the viscosity.

### Advantageous Effect of Invention

The invention, for the viscometers of the rotational types, the rotational vibration type and especially of the tuning fork vibration type, which can provide a new method to obtain the shear rate of the fluid from the measurement value, and which can distribute the elucidation making the physical properties of the fluid more realistic without use of the geometric shape of the device and with more reflection of the real behavior of the fluid by providing the program and the device for the tuning fork vibration type viscometer.

### BRIEF DESCRIPTION OF DRAWINGS

FIG. 1 is a schematic diagram to derive the definitional formula of viscosity.

FIG. 2 is a schematic view of a measuring part of the cone plate rotational type viscometer.

FIG. 3 is a schematic view of a measuring part of the coaxial double cylinder rotational type viscometer.

FIG. 4 is a configuration of the tuning fork vibration type viscometer of the embodiment.

FIG. 5 is a block diagram of a driving and controlling system of the tuning fork vibration type viscometer.

FIG. 6 is a flowchart to measure the shear rate by the tuning fork vibration type viscometer of the present invention.

FIG. 7 is a graph showing a relation of shear rates and shear stresses, when a Newtonian fluid is measured by the above mentioned viscometer.

FIG. 8 is a graph showing a relation of shear rates and shear stresses, when a non Newtonian fluid is measured by the above mentioned viscometer.

FIG. 9 is a graph showing a relation of shear rates and viscosities, when a plurality of Newtonian fluids are measured by the above mentioned viscometer.

FIG. 10 is a schematic view of a measuring part of the rotational vibration type viscometer.

FIG. 11 is a flowchart to measure the shear rate which is common to the rotational type viscometer and the rotational vibration type viscometer of the present invention.

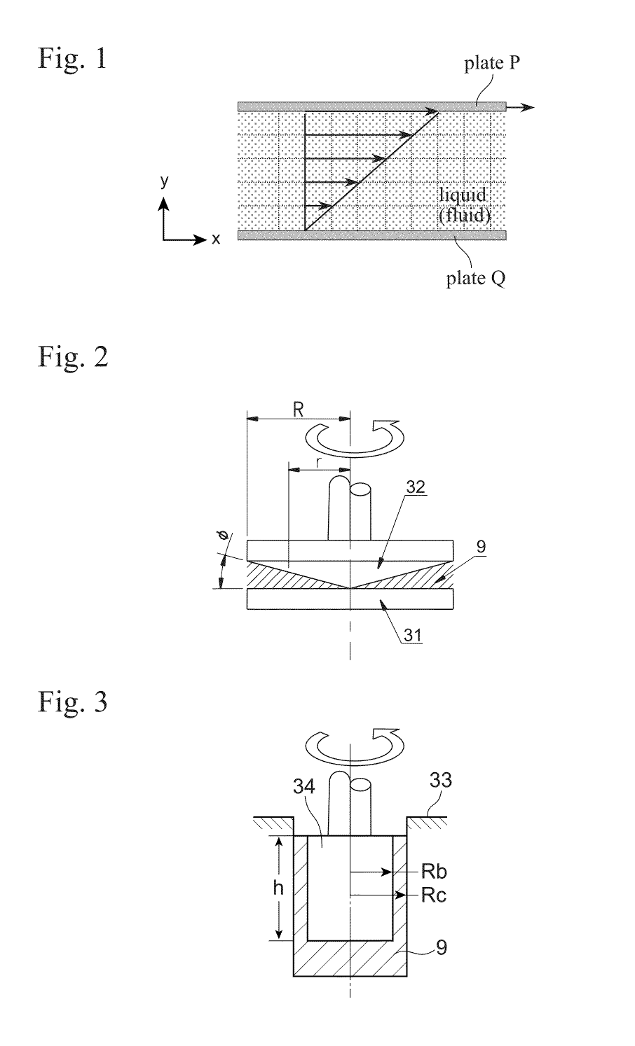

### DESCRIPTION OF EMBODIMENTS

Next, suitable embodiments of the present invention will be described.

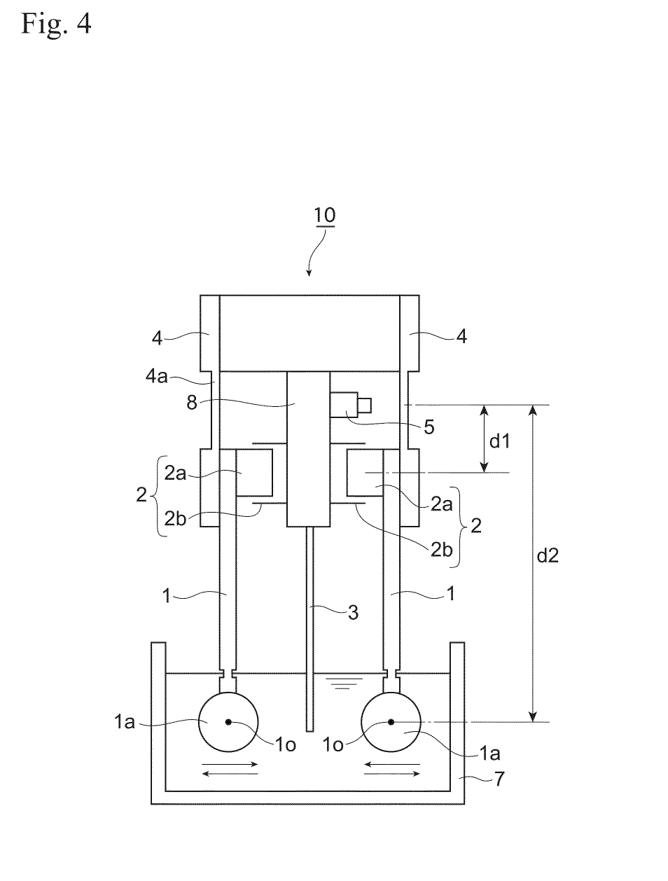

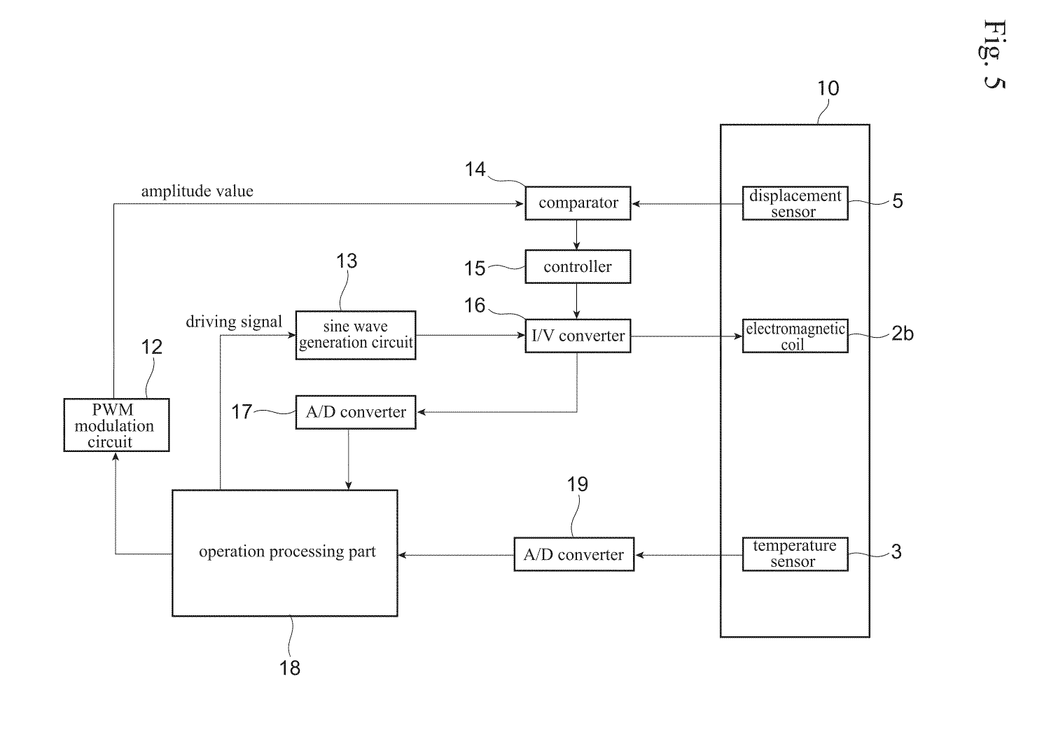

FIG. 4 is a configuration of the tuning fork vibration type viscometer, and particularly, is a configuration of a drive mechanism part 10 in a main body of the viscometer. The configuration of the main body of the viscometer and the description of the drive mechanism part 10 are described in the Patent Literature 2.

Reference signs 1,1 in the drive mechanism part 10 are a pair of vibrators which are dunked in the sample liquid 9, each of which is made of a thin plate of a ceramic or a metallic member, etc, and of which a leading end is provided with a rounded limb portion. The limb portion is a wet part 1a contacted with the sample liquid 9. Central axes in a thickness direction of the pair of vibrators 1,1 are arranged so as to be positioned on the same plane in the sample liquid 9.

Reference sign 7 is a container which is filled with the sample liquid 9, and Reference sign 3 is a temperature sensor. Reference signs 4,4 are plate springs which are fixed to the vibrators 1,1 at the leading ends thereof. Reference sign 8 is a center support member to which the plate spring 4,4 are fixed and which is configured to dunk the vibrators 1,1 in the sample liquid at a constant depth.

Reference sign 2b is an electromagnetic coil, Reference sign 2a is a ferrite magnet, and by a moving magnet type electromagnetic drive 2 which is made of the electromagnetic coil 2b and the ferrite magnet 2a, the vibrators 1, 1 which fixed on the leading end of the plate springs 4,4 are vibrated so as to be set a predetermined amplitude value. Reference sign 5 is a noncontact type displacement sensor for detecting eddy current losses which measures an amplitude value of the vibrators 1,1.

Next, FIG. 5 is a block diagram of a driving and controlling system of the tuning fork vibration type viscometer.

Reference sign 12 is a PWM modulation circuit, Reference sign 13 is a sine wave generation circuit, Reference sign 14 is a comparator, Reference sign 15 is a controller, Reference sign 16 is an I/V converter, Reference signs 17 and 19 are A/D converters, and Reference sign 18 is an operation processing part.

The vibrators 1,1 dunked in the sample liquid 9 receive a driving signal from the operation processing part 18 so as to be vibrated in an predetermined amplitude value, then a driving current generated via the sine wave generation circuit 13 is energized to the electromagnetic coil 2b of the electromagnetic drive 2 and exerted on the plate springs 4,4. In this manner, the vibrators 1,1 are vibrated in a reverse phase and resonated. The amplitude value of the vibrators 1,1 is detected by the displacement sensor 5, the signal of the detected amplitude value is compared with the predetermined amplitude value in the comparator 14, and a signal is outputted from the controller 15 for vibrating the vibrators 1,1 at the predetermined amplitude value, and thereby, a feedback control is executed therein. After the vibrators 1,1 become to be vibrated in the predetermined amplitude value, a driving current “I” energized to the electromagnetic coil 2b is detected. Then, the driving current I is inputted to the operation processing part 18 via the I/V converter 16 and the A/D converter 17, the viscosity of the sample liquid 9 is calculated. The process of calculating the viscosity is described in the Patent Literature 1. Also, an input signal from the temperature sensor 3 is inputted to the operation processing part 18 via the A/D converter 19.

The PWM modulation circuit 12 is connected between the operation processing part 18 and the comparator 14, and since the PWM modulation circuit 12 performs pulse width modulation to the amplitude value inputted to the comparator 14 by receiving orders from the operation processing part 18, the predetermined amplitude value is changed arbitrarily, the amplitude of the vibrators 1,1 is changed in the measurement, and the shear rate generated in the sample liquid 9 is changed.

A memory 21, a display 22, and key switches 23, etc, (each of them is not illustrated) are connected to the operation processing part 18, an user can set up terms of measurement by using the key switches 23. The terms of measurement include, for example, a measuring time, setting of the change of the amplitude (inputting an upper limit and a lower limit of the amplitude, the determination of an amount of change of the amplitude per time, and whether the amplitude is raised, fallen or reciprocated), etc. These details are described in WO2012/074654.

Next, a new method of obtaining the shear rate of the sample liquid 9 by using the above described tuning fork vibration type viscometer will be described in detail. The operation processing part 18 performs the calculations in the following steps.

(A Step of Calculating the Shear Stress)

In the tuning fork vibration type viscometer, an energy necessary for reciprocation motion is measured as a necessary power for moving the vibrator 1 in the sample liquid 9 (a torque) when the vibrator 1 is reciprocated in accordance with a sine wave in the sample liquid 9. Thus, the shear stress S generated between the sample liquid 9 and the vibrator 1 can be calculated, (refer to a formula (4)), by dividing a driving force “F” on a center 1o of the wet part 1a of the vibrator 1 by a liquid contact area “A” of the vibrator 1 (an area of the wet part 1a). The liquid contact area A is a known value obtained by the configuration of the viscometer's device.

S=F/A (4)

The driving force F which is necessary for the step of calculating the shear stress can be calculated from a step of calculating the driving force.

(A Step of Calculating the Driving Force)

The driving force F on the center of the wet part of the vibrator 1o is calculated by dividing a power “F1” generated in the electromagnetic drive 2 by a ratio (a lever ratio) “a” which is between a distance “d1” to a vertical center of the electromagnetic drive 2 and a distance “d2” to the center of the wet area 1o of the vibrator on a basis of a vertical center of the thinnest part 4a of the plate spring 4 acting as a fulcrum of the vibrator 1 (refer to the formula (5)). The lever ratio α is a known value obtained by the configuration of the viscometer.

F=F1/α (5)

The power F1 generated in the electromagnetic drive 2 can be calculated from a product of a density of magnetic flux “B” of the coil 22, the driving current “I” flowing in the coil 22, and a coil length “L” of the coil 22 (refer to the formula (6)). The density of magnetic flux B and the coil length L are known quantities by the configuration of the viscometer.

F1=BIL (6)

Here, if the driving current I is treated as an effective value, the driving force F on the center of the wet part of the vibrator 1o is calculated by the formula (7) by using a first step of calculating the power F1 generated in the electromagnetic drive 2 in the formula (6) and a second step of substituting the value of F1 for the formula (5).

F=BIL/α (7)

(A Step of Calculating the Viscosity)

A viscosity η of the sample liquid 9 is obtained by the above mentioned measurement. If the viscosity η of the sample liquid 9 is the known quantity beforehand, it is allowed to be inputted from the key switches 23 or to be read as a prerecorded value from the memory 21.

In this manner, the viscosity η of the sample liquid 9 becomes a known quantity, the shear rate D generated in the sample liquid 9 can be calculated from the formula (8) by using the formula (1), the formula (4) and the formula (7).

D=BIL/αηA (8)

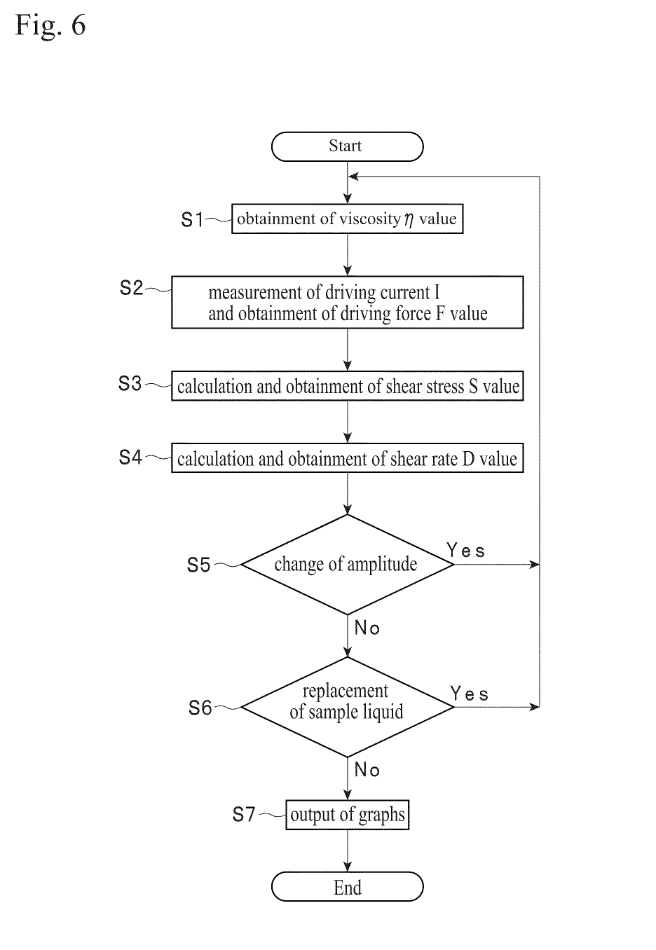

FIG. 6 is a flowchart to measure the shear rate by the tuning fork vibration type viscometer in accordance with the present invention.

When the measurement is started, the process proceeds to step S1 in which the value of viscosity η of the sample liquid 9 is obtained from the step of calculating the viscosity. In case of the real measurement, it is preferable the viscosity η is determined at the moment when the measurement value is judged to become stable after the measurement stating. In case of the non-measurement, the inputted value or the read-out value is obtained from the memory 21. Next, the process proceeds to step S2, in which the driving current I is measured, and the driving force F of the center of the wet part 1o from the step of calculating the driving force is measured for obtaining the value. Next, the process proceeds to step S3, in which the shear stress S is calculated from the step of calculating the shear stress for obtaining the value. Next, the process proceeds to step S4, in which the shear rate D is calculated from the ratio between the shear stress S and the viscosity η which is obtained from the above for obtaining the value. Next, the process proceeds to step S5, in which the value of the predetermined amplitude of the vibrator 1 is changed, and backs to the step S1. If the predetermined amplitude becomes the predetermined final value, the process proceeds to step S6, the sample liquid 9 is replaced with another sample liquid, and the process backs to the step S1. If it is no need for replacing the sample liquid, the process proceeds to step S7, graphs of the rheogram, etc, are outputted, and the measurement is stopped.

The graphs which are outputted in the step S7 can be prepared by using any plotted values such as, in its vertical axis and horizontal axis, the shear rate D of the sample liquid 9, the shear stress S, the viscosity η, the driving force F, the amplitude value of the vibrator 1, and the temperature measured by the temperature sensor 3 of the sample liquid 9, which are arbitrarily specified. Also, all outputted data of plural sample liquids can be brought altogether.

Next, the invention of the present application will be explained in more detail by using following embodiments, but the invention is not limited thereto. By the way, the liquid contact area A of the tuning fork vibration type viscometer was 0.000304 [mm], the lever ratio α was 3.81, the magnetic flux of the coil 22 B was 0.308 [web/m²], and the coil length L was 4 [m], in the following measurement.

### Embodiment 1

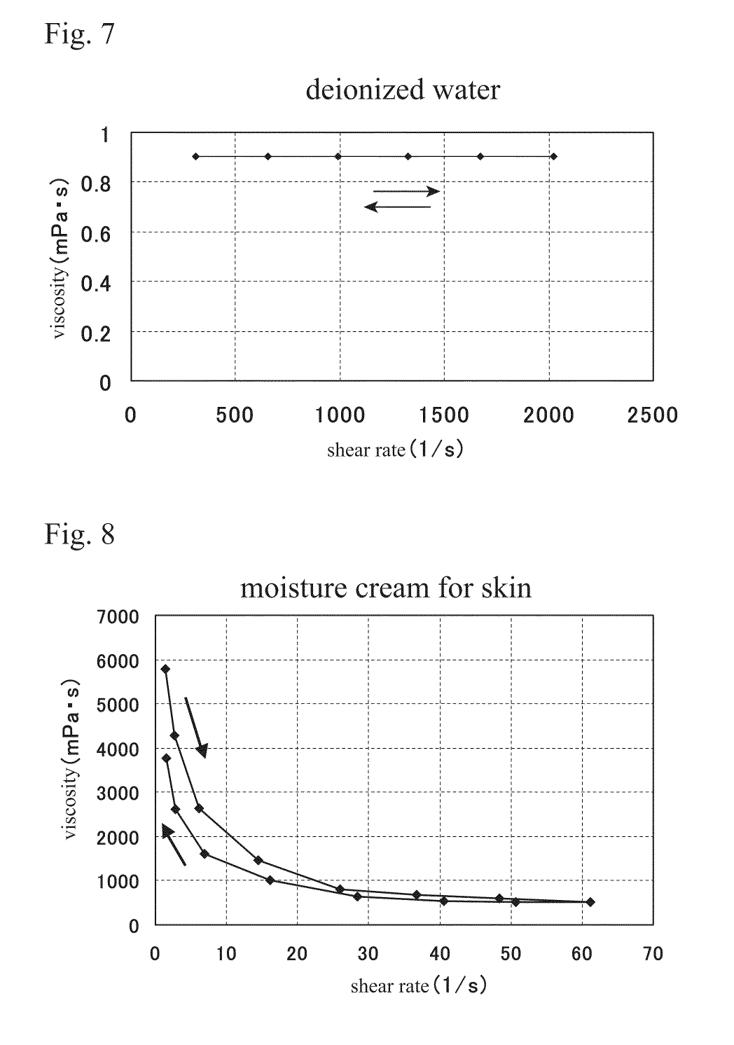

45 ml a deionized water which was a Newtonian fluid (under the constant temperature 25 [degrees centigrade] condition) was used as a sample liquid. The terms of the measurement were followings, the measurement time was 11 minutes, the lower limit value of the amplitude was 0.2 mm, the upper limit value was 1.2 mm, the amount of change of the amplitude per time was 0.2 mm/minute, and the amplitude was reciprocated after the raising and the falling. Also, the viscosity of the deionized water (25 [degrees centigrade]) was the known quantity (in accordance with JIS Z8803), so that the measurement was done by inputting the known quantity. The results of the shear rate obtained by the measurement are shown in FIG. 7. The horizontal axis is the shear rate [1/s] and the vertical axis is the viscosity [mPa*s].

### Embodiment 2

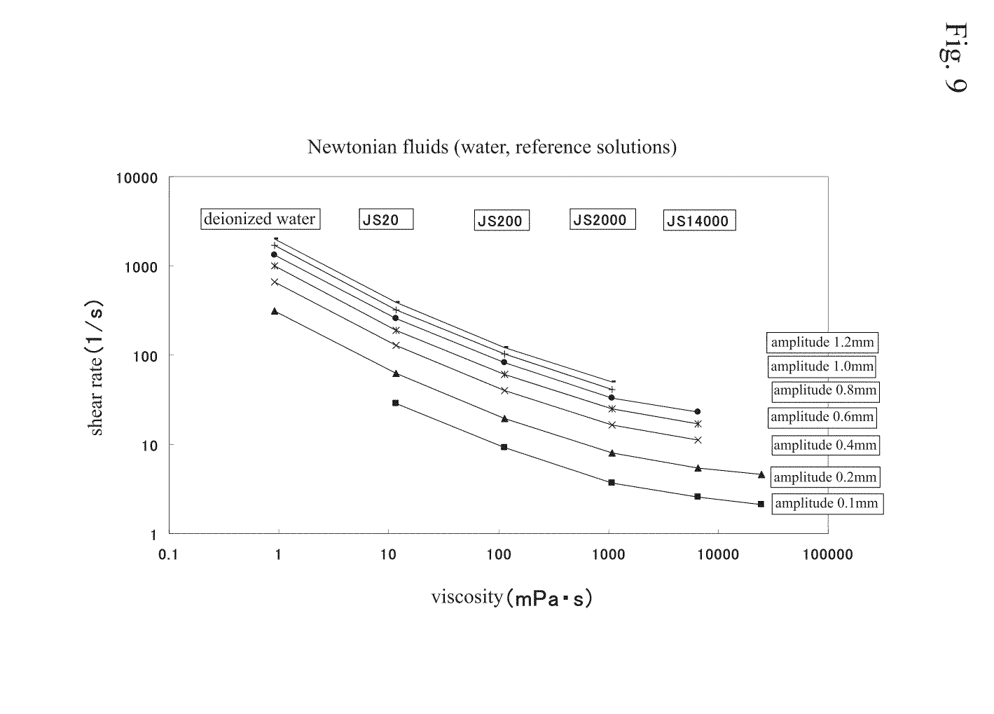

45 ml a moisture cream for skin which was a non Newtonian fluid (under the constant temperature 25 [degrees centigrade] condition) was used as a sample liquid. The terms of the measurement were followings, the measurement time was 15 minutes, the lower limit value of the amplitude was 0.07 mm, the upper limit value was 1.2 mm, the amount change of the amplitude were 0.07, 0.1, 0.2, 0.4, 0.6, 0.8, 1.0, 1.2 mm, each of them was changed per 1 minute. The amplitude was reciprocated after the raising and the falling. The values of viscosity were obtained from the start of the measurement in every one minute after the respective amplitudes were changed. The results of the shear rate are shown in FIG. 8. The horizontal axis is the shear rate [1/s] and the vertical axis is the viscosity [mPa*s].

### Embodiment 3

45 ml a deionized water and 45 ml reference solutions JS 20, JS200, JS2000, and JS14000 all of which were Newtonian fluids (each of them under the constant temperature 25 [degrees centigrade] condition) were used as sample liquids. The terms of the measurement were the same as those of the embodiment 1. Also, since each of the viscosities is the known quantity (in accordance with JIS Z8803), the measurements were done by inputting the known quantities. The results of the shear rates are shown in FIG. 9 by drawing lines of the respective liquids. The horizontal axis is the viscosity [mPa*s] and the vertical axis is shear rate [1/s].

From the above, in the method of obtaining the shear rate by the present invention, since the shear rate is calculated by measured values, that is, the driving force F (the driving current I) and the viscosity η which may include a known value, the shear rate can be obtained without the influence of the geometric shape of the device and with reflection of the real behavior of the fluid, and the method can contribute to the elucidation of the physical properties of the fluid which are more close to an actual situation.

Next, a method of obtaining the shear rate by a rotational type viscometer will be described.

In the cone plate rotational type viscometer, as shown in FIG. 2, the sample liquid 9 which is filled between the plate 31 and the cone rotor 32 with the same center axis is rotated and flows in a laminar flow by the cone rotor 32 acting as a rotor at rotating number N [rpm], the torque “τ” exerted on the plate 31 is detected for calculating the viscosity. The calculating process of the viscosity is described in the Non Patent Literature 1. Then, since the measured torque τ is the same value as the shear stress S which is generated in the sample liquid 9, the value of the shear stress S can be obtained by measuring the torque τ.

In the coaxial double cylinder rotational type viscometer, as shown in FIG. 3, the sample liquid 9 which is filled between the outer cylinder 33 and the inner cylinder 34 with the same center axis is rotated and flows in a laminar flow by the inner cylinder 34 as the rotor at rotating number N [rpm], the torque τ exerted on the cylinder of the outer cylinder 33 is detected for calculating the viscosity. The detail of the configuration of the device and the calculating process of the viscosity is described in the Non Patent Literature 1. Similarly, since the measured torque τ is the same value as the shear stress S which is generated in the sample liquid 9, the value of the shear stress S can be obtained by measuring the torque τ.

Thus, when the viscosity η of the sample liquid 9 is obtained by the measurement described in the above (the step of calculating the viscosity) and when the value of the shear stress S (the value of the torque τ) is obtained (the step of calculating the shear stress), the shear rate D generated in the sample liquid 9 can be obtained by the ratio between the measured torque τ and the known quantity viscosity η, from the formula (1) wherein it is regarded S=T (refer to the formula (9)).

D=τ/η (9)

Also, when the viscometer is the type which is equipped the plate 31 and the outer cylinder 33 as the rotor, it is needless to say that the shear rate D can be obtained from the formula (9) by measuring the torque τ exerted on the other side element.

Next, a new method of obtaining the shear rate by a rotational vibration type viscometer will be described in detail.

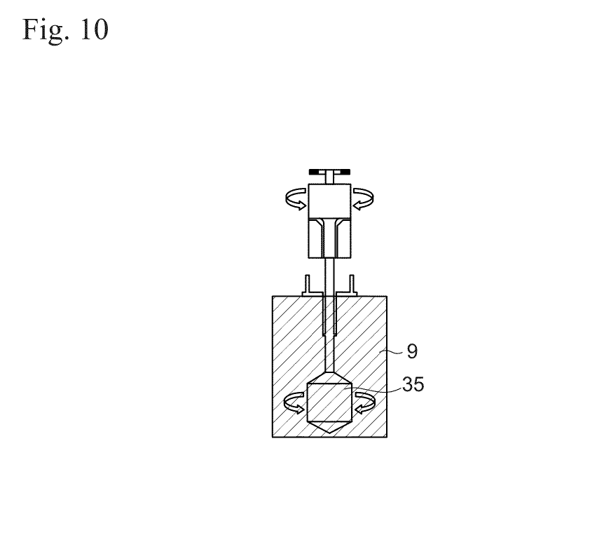

In the rotational vibration type viscometer, as shown in FIG. 10, a cylinder-shaped-vibrator 35 is dunked and resonated in a rotating direction in the sample liquid 9, the torque τ necessary for keeping the cylinder-shaped-vibrator 35 in a constant amplitude is measured, and the viscosity is calculated. The detail of the configuration of the device and the calculating process of the viscosity is described in the Non Patent Literature 1.

Thus, similarly to the rotational type viscometer described above, when the viscosity η of the sample liquid 9 is obtained or is inputted in case it is the known quantity (the step of calculating the viscosity) and when the value of the shear stress S (the value of the torque τ) is obtained (the step of calculating the shear stress), the shear rate D generated in the sample liquid 9 can be obtained by using the formula (9).

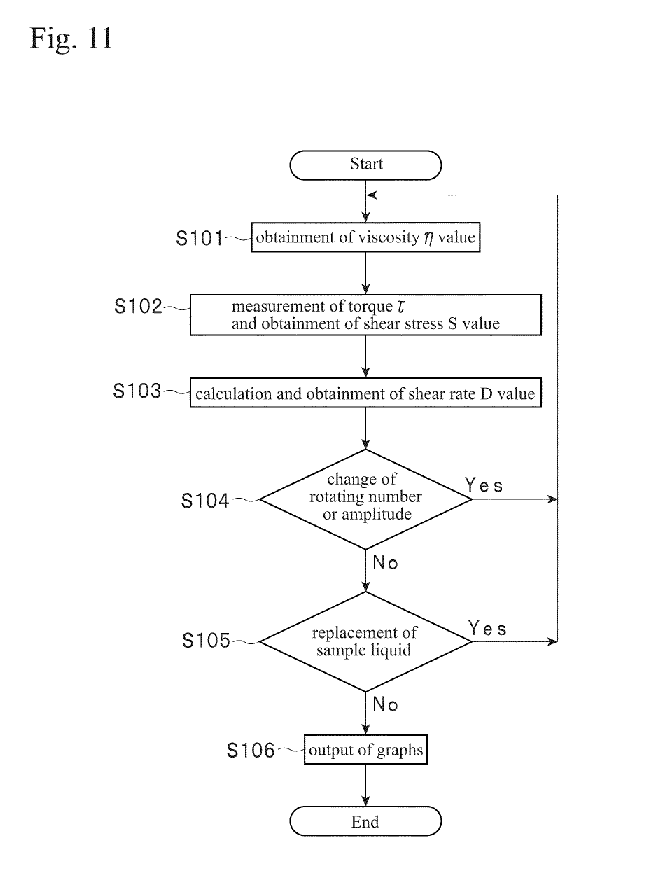

FIG. 11 is a flowchart showing a method to measure the shear rate which is common to the rotational type viscometer and the rotational vibration type viscometer in accordance with the present invention.

When the measurement is started, the process proceeds to step S101, it measures the viscosity η of the sample liquid 9 and obtains the value from the step of calculating the viscosity. Next, the process proceeds to step S102, it measures the torque τ and obtains the value defined as the shear stress S from the step of calculating the shear stress. Next, the process proceeds to step S103, it calculates the shear rate D from the ratio between the measured shear stress S and the measured viscosity and obtains the values. Next, the process proceeds to step S104, it changes the rotating number in the rotational type viscometer or changes the amplitude in the rotational vibration type viscometer, and backs to the step S101. If it is no need for changing the rotating number or the amplitude, the process proceeds to step S105, the sample liquid 9 is replaced to another sample liquid, and backs to the step S101. If it is no need for replacing the sample liquid, the process proceeds to step S106, it outputs graphs of the rheogram, etc, and stops the measurement.

Arbitrary values selected from, for example, the shear rate D of the sample liquid 9, the shear stress S and the viscosity η are assigned to its vertical and horizontal axes for outputting the graph in the step S106. Also, the graphs can be outputted by using all data of a plurality of the sample liquids altogether.

From the above, the method of the present invention can be applied to other than the turning fork vibration type viscometer, and be applied not only to the rotational vibration type viscometer but also to the rotational type viscometer in accordance with the same thinking. Each of the rotational type viscometer and the rotational vibration type viscometer has the device configuration in which the cone rotor 32 or the inner cylinder 34 or the cylinder-shaped-vibrator 35 rotates, and these viscometers measure the torque τ necessary for keeping their rotation. Therefore, the shear rate D can be obtained by the ratio between the measured torque τ and the known quantity viscosity η from the formula (9).

Thus, the present invention can provide the method to obtain the shear rate without use of the geometric shape of the device and with reflection of the real behavior of the fluid in both of the rotational type viscometer and the rotational vibration type viscometer.

### REFERENCE SIGNS LIST

1 . . . vibrator, 1a . . . wet part, 1o . . . center of wet part, 2 . . . electromagnetic drive, 2a . . . ferritemagnet, 2b . . . electromagnetic coil, 3 . . . temperature sensor, 4 . . . plate spring, 4a . . . thinnest part of plate spring, 5 . . . displacement sensor, 7 . . . container, 9 . . . sample liquid, 10 . . . drive mechanism part, 32 . . . cone rotor as a rotor, 34 . . . cylinder as a rotor, 35 . . . cylinder shaped vibrator

1. A method of obtaining a shear rate occurring in a liquid sample for a tuning fork vibration type viscometer, in which a pair of vibrators are dunked in the sample liquid and vibrated by an electromagnetic drive equipped with a coil, a driving current is applied to the coil so as to set an amplitude of the vibrators within a predetermined amplitude value, and a viscosity of the sample liquid is calculated by measuring the driving current, comprising:
a step of calculating the viscosity of the sample liquid;
a step of calculating a driving force on a center of a wet part of the vibrator from the driving current; and
a step of calculating a shear stress exerted on the sample liquid from the driving force and a liquid contact area of the vibrator,
wherein the shear rate is calculated from a ratio between the shear stress and the viscosity.

2. The method of obtaining the shear rate according to claim 1, wherein the calculation of the driving force on the center of the wet part of the vibrator in the step of calculating the driving forth comprises:
a first step of calculating a power generated in the electromagnetic drive from a product of a density of magnetic flux, a driving current and a length of the coil of the electromagnetic drive; and
a second step of dividing the power generated in the electromagnetic drive by a ratio between a distance to a center of the electromagnetic drive and a distance to the center of the wet area of the vibrator on a basis of a thinnest part of a plate spring acting as a fulcrum of the vibrator.

3. A tuning fork vibration type viscometer, in which a pair of vibrators are dunked in a sample liquid and vibrated by an electromagnetic drive equipped with a coil, a driving current is applied to the coil so as to set an amplitude of the vibrators within a predetermined amplitude value, and a viscosity of the sample liquid is calculated by measuring the driving current, comprising:
a means of calculating the viscosity of the sample liquid;
a means of calculating a driving force on a center of a wet part of the vibrator from the driving current; and
a means of calculating a shear stress exerted on the sample liquid from the driving force and a liquid contact area of the vibrator,
wherein the shear rate is calculated from a ratio between the shear stress and the viscosity.

4. A program of calculating the shear rate in which the method of obtaining the shear rate according to claim 1 is executably programmed in a computer.

5. A method of obtaining a shear rate occurring in a liquid sample for a rotational type viscometer, in which a rotor is dunked and rotated in the sample liquid in laminar flow, a torque necessary for keeping the rotor in a constant rotating number in the sample liquid is measured, and a viscosity of the sample liquid is calculated, comprising:
a step of calculating the viscosity of the sample liquid; and
a step of obtaining a torque value as a shear stress occurring in the sample liquid,
wherein the shear rate is calculated from a ratio between the shear stress and the viscosity.

6. A method of obtaining a shear rate occurring in a liquid sample for a rotational vibration type viscometer, in which a vibrator is dunked and resonated in a rotating direction in the sample liquid, a torque of the vibrator necessary for keeping the vibrator in a constant amplitude in the sample liquid is measured, and a viscosity of the sample liquid is calculated, comprising:
a step of calculating the viscosity of the sample liquid; and
a step of obtaining a torque value as a shear stress occurring in the sample liquid;
wherein the shear rate is calculated from a ratio between the shear stress and the viscosity.
